(19) United States
(12) Patent Application Publication
(10) Pub. No.: US 2004/0187342 A1
(43) Pub. Date: Sep. 30, 2004

(54) Substrate treating method and apparatus

(75) Inventor: Takashi Izuta, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/806,885

(22) Filed: Mar. 22, 2004

(30) Foreign Application Priority Data
Mar. 25, 2003 (JP) 2003-083180

(51) Int. Cl. F26B 5/04

(52) U.S. Cl. 34/467

(57) ABSTRACT

A substrate treating apparatus for performing etching treatment of a plurality of substrates by immersing the substrates collectively in a heated phosphoric acid solution. When the substrates are fetched from a container, a substrate counting mechanism and a substrate counter count the substrates to be treated collectively. A processing time determining unit determines a processing time according to a count of the substrates, by referring to a relationship between count of substrates and processing time stored in a storage unit. Since the processing time is adjusted according to the number of substrates in a lot to be treated collectively, variations in the amount of etching are suppressed even when the number of substrates differs from one lot to another.

### BACKGROUND OF THE INVENTION

(1) Field of the Invention

This invention relates to a substrate treating method and apparatus for performing a predetermined treatment of semiconductor wafers, glass substrates for liquid crystal displays, glass substrates for photomasks and substrates for optical disks (hereinafter called simply “substrates”). More particularly, the invention relates to a substrate treating method and apparatus for performing a predetermined treatment of substrates by immersing a plurality of substrates collectively in a heated treating solution.

(2) Description of the Related Art

A substrate treating apparatus of this type is known from Japanese Unexamined Patent Publication No. 11-145107 (1999), for example, which performs a selective etching treatment of silicon nitride film formed on surfaces of substrates such as semiconductor wafers. This apparatus includes a treating tank for storing a heated phosphoric acid solution, and a vertically movable mechanism called a lifter for holding a plurality of (e.g. 50) substrates in vertical posture. The lifter holding the substrates is lowered into the treating tank to immerse the substrate in the phosphoric acid solution for batch treatment.

The conventional apparatus having such a construction has the following drawback.

Since the rate of etching the silicon nitride film is influenced by the concentration and temperature of the phosphoric acid solution, the concentration and temperature of the solution are strictly controlled. However, the substrates are treated in batches or in units of lots, and such treatment is subject to an inconvenience of the etching rate varying from lot to lot.

### SUMMARY OF THE INVENTION

This invention has been made having regard to the state of the art noted above, and its object is to provide a substrate treating method and apparatus capable of suppressing variations in treatment occurring from lot to lot.

To fulfill the above object, Inventor has made intensive research and attained the following findings.

Inventor has noted that the number of substrates included in each lot is not necessarily fixed, but the number is variable from lot to lot. Then, a lot of three substrates and a lot of 50 substrates were individually immersed in a phosphoric acid solution at 150° C., and temperature changes of the phosphoric acid solution were measured immediately after the immersion. The former lot causes a temperature change less than 1° C. of the phosphoric acid solution, while the latter lot caused a temperature change of about 5° C. The rates of etching the substrates actually measured were 37.96 to 38.58 Å/min. for the former lot, and 33.13 to 33.66 Å/min. for the latter lot. It has been found through this experiment that the variations in treatment of different lots encountered in the prior art are due to different temperature changes of the treating solution caused by differences in the number of substrates included in the lots.

Based on the above findings, this invention provides a substrate treating method for performing a predetermined treatment of a plurality of substrates as immersed in a heated treating solution, wherein the substrates are immersed in the treating solution for a progressively extended time as the substrates treated increase in number.

This invention provides the following functions and effects. As the substrates treated collectively increase in number, the temperature of the heated treating solution is lowered by a large degree by the substrates immersed therein. Consequently, treating efficiency (e.g. etching rate) also lowers to a large extent. In the method according to this invention, the processing time is extended to an extent corresponding to a lowering of treating efficiency. In this way, a proper amount treatment is secured for each lot, to suppress variations in the treatment occurring with different lots.

A substrate treating apparatus, according to this invention, for performing a predetermined treatment of a plurality of substrates as immersed in a heated treating solution, comprises: a substrate count acquiring device for acquiring a count of the substrates to be treated; a storage device for storing beforehand a relationship between count of the substrates and processing time for immersion in the heated treating solution; a processing time determining device for determining a processing time according to the count of the substrates acquired by the substrate count acquiring device, by referring to the relationship stored in the storage device; and a treating device for immersing the substrates in the heated treating solution for the processing time determined by the processing time determining device.

With the apparatus according to this invention, the substrate count acquiring device acquires a count of the substrates to be treated collectively, and applies the count to the processing time determining device. The processing time determining device determines a processing time according to the count of the substrates to be treated collectively, by referring to the relationship between count of the substrates and processing time stored in the storage device. The processing time determined is given to the treating device, whereby the substrates are immersed in heated treating solution for the processing time according to the count of the substrates. As a result, variations in the treatment are suppressed even when the number of substrates differs from one lot to another which is a unit of substrates treated collectively.

The substrate count acquiring device is not limited to a particular construction, but may, for example, a container storing a plurality of substrates to be treated is placed on a container rest, the substrate count acquiring device, preferably, counts the substrates in the container.

Where the above container is placed on the container rest, the substrate count acquiring device may be disposed in or mounted on varied locations or components. The substrate count acquiring device may be mounted on a shutter provided for opening and closing an opening in a partition acting as an atmospheric barrier between the container rest and a treating station, or may be disposed separately from the shutter. The substrate count acquiring device may be mounted on a substrate loading robot for fetching the substrates to be treated from the container and depositing treated substrates in the container.

Other examples of the substrate count acquiring device include a transmission type optical sensor (transmission type optical sensor), a reflection type optical sensor and a CCD camera.

The substrate count acquiring device may be arranged to acquire the count of the substrates to be treated, in form of data given from an external device, or in form of a key input from a control unit.

The treating device is not limited to a particular construction, but may, preferably, be arranged to withdraw the substrates from the heated treating solution upon lapse of the processing time, and immerse the substrates in a cleaning liquid. Alternatively, the treating device may be arranged to introduce a cleaning liquid into a treating tank storing the heated treating solution upon lapse of the processing time, to replace the treating solution in the treating tank with the cleaning liquid.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a plan view showing an outline of a substrate treating apparatus according to this invention;

FIG. 2 is a perspective view of a principal portion of the apparatus;

FIG. 3 is a view showing an outline of a control system;

FIG. 4 is a perspective view of a principal portion of a substrate counting mechanism;

FIG. 5 is a view showing a relationship between substrate count and treating time; and

FIG. 6 is a flow chart of a treating time control.

### DESCRIPTION OF THE PREFERRED EMBODIMENTS

A preferred embodiment of this invention will be described in detail hereinafter with reference to the drawings.

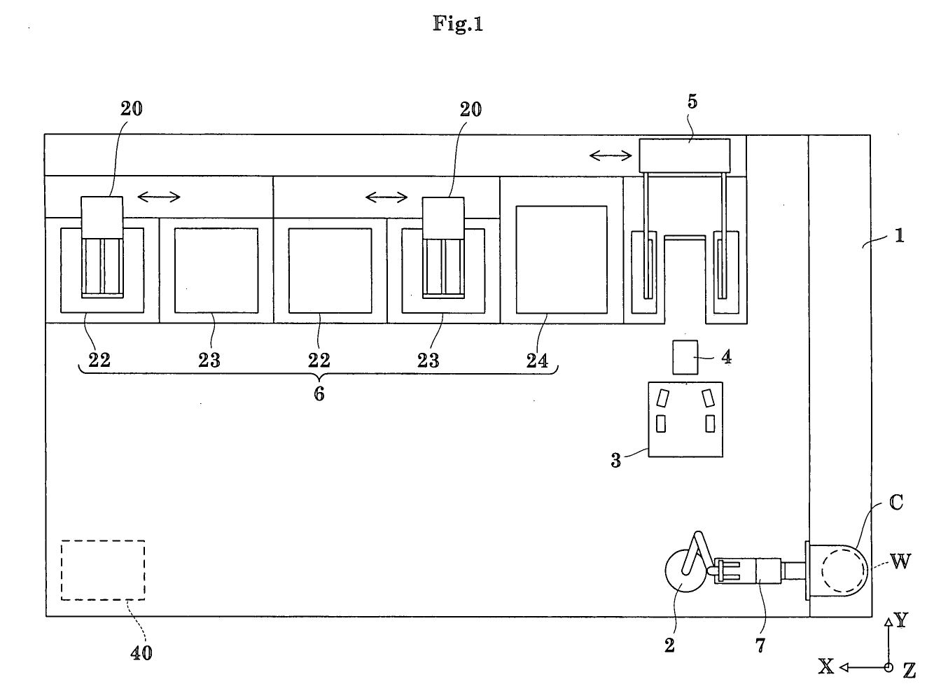

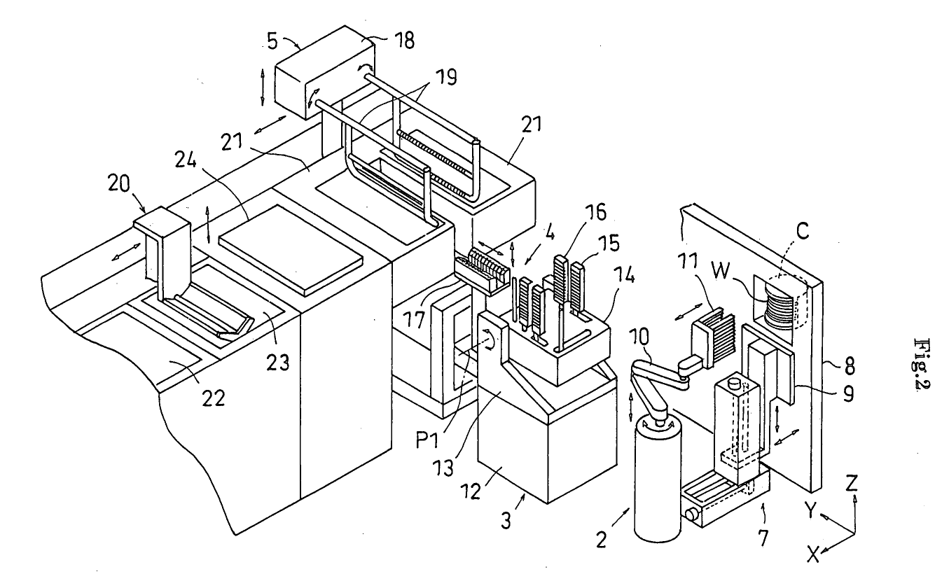

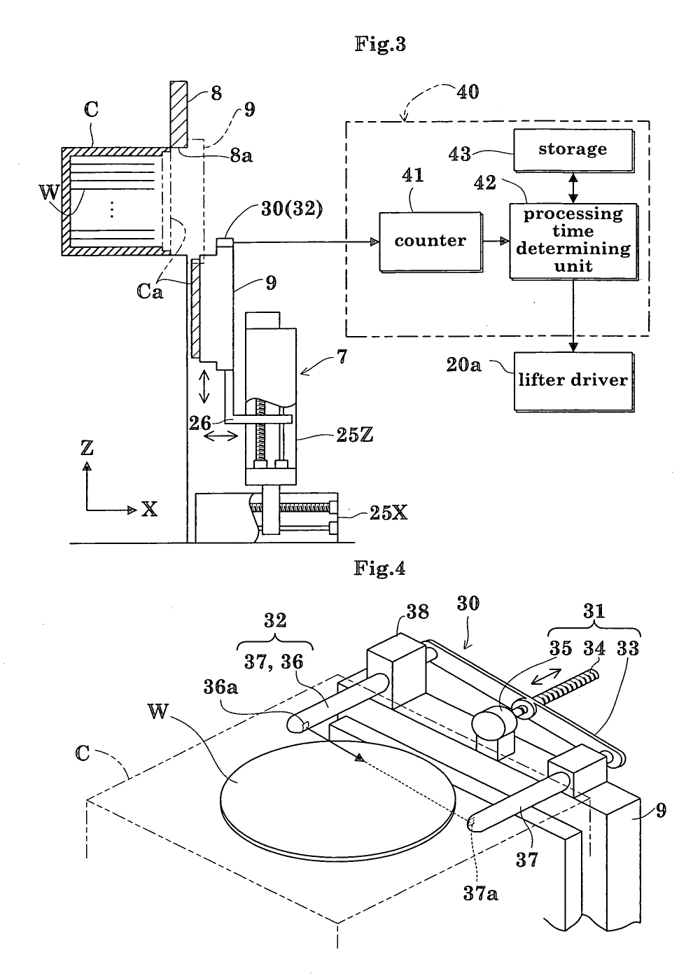

FIG. 1 is a plan view showing an outline of a substrate treating apparatus according to this invention. FIG. 2 is a perspective view of a principal portion of the apparatus. FIG. 3 is a view showing an outline of a control system. FIG. 4 is a perspective view of a principal portion of a substrate counting mechanism.

The substrate treating apparatus in this embodiment is used for etching silicon nitride film formed on surfaces of wafers W (e.g. semiconductor wafers) by immersing a plurality of wafers W in batches in a heated phosphoric acid solution. However, this invention is not limited to the treatment with a phosphoric acid solution, but is applicable to treatment with any chemical solution (e.g. of sulfuric acid) or pure water as long as the solution is heated. The type of treatment is not limited to etching treatment, either.

As shown in FIG. 1, the substrate treating apparatus, broadly, includes a container rest 1 for receiving thereon a container C storing wafers W to be treated collectively, a substrate transfer robot 2 for fetching the wafers W to be treated from inside the container C and for loading treated wafers W into the container C, a posture changing mechanism 3 for changing a posture of wafers W all together from horizontal to vertical (upstanding) or vice versa, a pusher 4 for receiving and delivering the wafers W from/to the posture change mechanism 3, a substrate transport mechanism 5 for receiving and delivering the wafers W from/to the pusher 4 and transporting the wafers W, and a treating station 6 for batch-treating the wafers W transported by the substrate transport mechanism 5.

Between the container rest 1 and substrate transfer robot 2, a shutter drive mechanism 7 is disposed for opening and closing an opening 8a in a partition 8, as described hereinafter. The shutter drive mechanism 7 includes a substrate counting mechanism 30 which is one of the features of this apparatus (see FIGS. 3 and 4). The substrate counting mechanism 30 is provided for counting the wafers W in the container C placed on the container rest 1.

Each component of the apparatus will particularly be described hereinafter.

The container C stores a plurality of (e.g. 25) wafers W in horizontal posture. The container C has a lid Ca (FIG. 3) detachably attached to an access opening thereof for sealing the interior of container C from ambient air.

As shown in FIGS. 2 and 3, the partition 8 acting as an atmospheric barrier is disposed between the container rest 1 and the treating station 6. The partition 8 defines an opening 8a for allowing passage of the wafers W. The container C is placed on the container rest 1 to be opposed to this opening 8a. When the treatment of wafers W is off, the opening 8a is closed by a shutter 9.

The substrate transfer robot 2 includes an articulated arm 10 which is vertically movable, swivelable and movable back and forth. The articulated arm 10 has U-shaped holding arms 11 attached in multiple stages to a distal end thereof for holding wafers W. The substrate transfer robot 2 fetches and deposits the wafers W en bloc from/in the container C by using this holding arm 11. Of course, the substrate transfer robot 2 may fetch and deposit one wafer W at a time.

The posture changing mechanism 3 includes a support block 12, a base 13 mounted on the support block 12, and a swing deck 14 supported on the base 13 to be pivotable about an axis PI. The swing deck 14 has a pair of first holding mechanisms 15 and a pair of second holding mechanisms 16 for supporting the wafers W in multiple stages. By a drive mechanism not shown, the swing deck 14 is switchable between a horizontal posture shown in FIG. 2 and a vertical posture turned 90 degrees therefrom. Consequently, the wafers W supported by the first and second holding mechanisms 15 and 16 may be changed from horizontal posture to vertical posture (or vice versa).

The pusher 4 is disposed adjacent the swing deck 14. The pusher 4 is movable vertically (Z-direction) and horizontally (Y-direction), and includes a holder 17 mounted on top for holding the wafers W in vertical posture. The pusher 4 transfers the wafers W between the posture changing mechanism 3 and substrate transport mechanism 5.

The substrate transport mechanism 5 includes a transport robot 18 movable horizontally (X-direction) along the treating station 6 and vertically, and a pair of pinching mechanisms 19 capable of an open and close motion and extending horizontally from the transport robot 18. The substrate transport mechanism 5 in a standby position shown in FIGS. 1 and 2 receives and delivers the wafers W from/to the pusher 4, and transports the wafers W received to the treating station 6. The substrate transport mechanism 5 also receives and delivers the wafers W from/to lifters 20 provided for the treating station 6. In the standby position of the substrate transport mechanism 5, a pair of rinsing tanks 21 are disposed for rinsing the pair of pinching mechanisms 19. The pusher 4 is movable into a space between the pair of rinsing tanks 21.

The treating station 6 includes two units, each having a treating tank 22 for storing a heated phosphoric acid solution, and a cleaning tank 23 for cleaning wafers W treated with the phosphoric acid solution. The treating station 6 further includes a drying section 24 disposed adjacent the standby position of the substrate transport mechanism 5. Each unit has a lifter 20 movable vertically and horizontally in X-direction for immersing the wafers W received from the substrate transport mechanism 5 all together in the treating tank 22, and immersing treated wafers W together in the cleaning tank 23.

As shown in FIG. 3, the shutter drive mechanism 7 has the shutter 9 connected to and supported by a support arm 26 movable back and forth (in X-direction) and up and down by two screw feed mechanisms 25X and 25Z. When the support arm 26 moves forward in an upper limit position, as shown in a chain line in FIG. 3, the shutter 9 closes the opening 8a in the partition 8. When the support arm 26 retracts and lowers, as shown in a solid line in FIG. 3, the shutter 9 is opened. The shutter 9 has an opening/closing and holding mechanism, not shown, for opening, closing and holding the lid Ca of the container C placed on the container rest 1. Consequently, the lid Ca of the container C is opened at the same time the shutter drive mechanism 7 opens the shutter 9, and is lowered with the shutter 9.

As shown in FIG. 4, the substrate counting mechanism 30 includes an advance/retract drive mechanism 31 mounted on the shutter 9, and a transmission type sensor 32 movable back and forth by the drive mechanism 31. The drive mechanism 31 is a screw feed mechanism having a screw shaft 34 meshed with a connecting member 33 and driven by an electric motor 35. The transmission type sensor 32 includes a light emitter 36 having a light emitting device 36a disposed in a distal end region thereof, and a light receiver 37 having a light receiving device 37a disposed in a distal end region thereof. The light emitter 36 and light receiver 37 are fixedly supported at proximal ends thereof by the connecting member 33. Further, the light emitter 36 and light receiver 37 extend through a pair of guide members 38 to be slidably supported therein, and are opposed to each other at different heights.

The substrate treating apparatus in this embodiment includes a controller 40 for controlling a time for immersing a group of wafers W in the treating tank 22 for batch treatment according to the number of wafers W counted by the substrate counting mechanism 30.

An operation of the substrate treating apparatus having the above construction for treating a plurality of wafers W collectively will be described.

After a container C containing a plurality of wafers W in horizontal posture is placed on the container rest 1, the shutter drive mechanism 7 opens the shutter 9 of the partition 8 and the lid Ca of the container C. As the shutter 9 lowers with the lid Ca, the transmission type sensor 32 of the substrate counting mechanism 30 is moved forward to advance the light emitter 36 and light receiver 37 of the sensor 32 along inner walls of the container C (i.e. the state shown in FIG. 4). As the shutter 9 lowers in this state, light emitted from the light emitting device 36a is intercepted by one wafer W after another. The light receiving device 37a detects the alternating interception and transmission of the light, and the resulting detection signal is sent to the controller 40. Based on the signal received from the transmission type sensor 32, the controller 40 determines the number of wafers W to be treated collectively, and determines a processing time (i.e. a time for immersion in the phosphoric acid solution) according to the number of wafers W. A procedure for determining the processing time will be described in detail hereinafter. When the transmission type sensor 32 reaches the bottom of the container C, the sensor 32 is retracted to the original position. The shutter 9 is further lowered to stop at a standby position.

When the shutter 9 has been opened as described above, the holding arm 11 of the substrate transfer robot 2 advances into the container C and fetches the group of wafers W all together from the container C. The substrate transfer robot 2 transfers the fetched group of wafers W to the posture changing mechanism 3. The swing deck 14 of the posture changing mechanism 3 is in horizontal posture at this time, and the group of wafers W is horizontally supported by the first holding mechanisms 15 and second holding mechanisms 16.

After receiving the group of wafers W, the swing deck 14 of the posture changing mechanism 3 swings 90 degrees toward the pusher 4. As a result, the group of wafers W supported by the first and second holding mechanisms 15 and 16 also are turned 90 degrees to assume an upstanding posture. At this time, the pusher 4 is in a lower position. Then, the pusher 4 is raised to receive the wafers W from the first and second holding mechanisms 15 and 16. This completes a first transfer of the wafers W to the pusher 4.

In this embodiment, a maximum of 50 wafers W may be treated collectively. The container C stores a maximum of 25 wafers W. Thus, after delivering the first group of wafers W, a different container C is placed on the container rest 1. As described above, a group of wafers W is fetched from the container C, transferred to the posture changing mechanism 3 for changing the posture of the wafers W, and transferred to the pusher 4. For transferring a second group of wafers W to the pusher 4, the pusher 4 is raised in a position slightly displaced horizontally (in Y-direction). Thus, the pusher 4 receives the second group of wafers W each in a space between the wafers W in the first group.

The pusher 4 having received a plurality of (a maximum of 50) wafers as described above moves horizontally toward the space between the pair of rinsing tanks 21. The pusher 4 having moved between the pair of rinsing tanks 21 then moves upward. At this time, the substrate transport mechanism 5 is in the standby position, with the pair of pinching mechanisms 19 in the open state. The pinching mechanisms 19 close after the pusher 4 arrives at a predetermined position above the lower end of the pinching mechanisms 19. Then, the pusher 4 lowers, thereby transferring the group of wafers W from the pusher 4 to the pair of pinching mechanisms 19.

The substrate transport mechanism 5 having received the group of wafers W moves horizontally along the treating station 6, and transfers the wafers W to one of the lifters 20 in the treating station 6. The lifter 20 having received the wafers W lowers into the treating tank 22 to immerse the wafers W en bloc in the heated phosphoric acid solution. Upon lapse of a processing time according to the number of wafers W under batch treatment, as described in detail hereinafter, the lifter 20 ascends to.withdraw the group of wafers W up from the phosphoric acid solution. Then, the lifter 20 moves horizontally to the cleaning tank 23, and the group of wafers W treated with the phosphoric acid solution is immersed in pure water in the cleaning tank 23. After cleaning treatment with the pure water, the lifter 20 ascends to withdraw the group of wafers W up from the cleaning tank 23. The group of wafers W withdrawn upward is transferred from the lifter 20 to the substrate transport mechanism 5 which transports the wafers W to the drying section 24. The group of wafers W delivered to and dried in the drying section 24 is transferred to the substrate transport mechanism 5 again. The substrate transport mechanism 5 transports the group of dried wafers W to the standby position.

The group of wafers W transported to the standby position is transferred from the substrate transport mechanism 5 to the pusher 4 in an operation reversed from the incoming time. The group of wafers W received by the pusher 4 is transferred to the posture changing mechanism 3 in two separate groups. The wafers W received by the posture changing mechanism 3 are turned from vertical posture to horizontal posture. The wafers W having undergone the posture change are returned to the containers C by the substrate transfer robot 2. This completes the series of substrate treating steps.

Next, a control of the processing time according to the number of wafers W to be treated collectively, which is a characteristic feature of this embodiment, will be described.

FIG. 3 refers. The signal of detection by the transmission type sensor 32 of the substrate counting mechanism 30 is applied to a substrate counter 41 of the controller 40. Based on the detection signal from the transmission type sensor 32, the substrate counter 41 counts the wafers W stored in containers C. In this embodiment, as described hereinbefore, the wafers W stored in two containers C are treated as a group. Thus, the substrate counter 41 adds together the numbers of wafers W stored in two containers C, and applies a total number to a processing time determining unit 42 as the number of wafers W to be treated collectively. Thus, the above substrate counting mechanism 30 and substrate counter 41 constitute the substrate count acquiring device which is one form of the substrate count acquiring device in this invention.

On the other hand, a storage unit 43 corresponding to the storage device in this invention stores a relationship between substrate count and processing time for immersion in the heated treating solution (e.g. a phosphoric acid solution in this embodiment). A processing time determining unit 42 corresponding to the processing time determining device in this invention refers to the relationship between substrate count and processing time stored in the storage unit 43, and determines a processing time according to a count of wafers W received from the substrate counter 41. The relationship between substrate count and processing time stored in the storage unit 43 will be described hereunder.

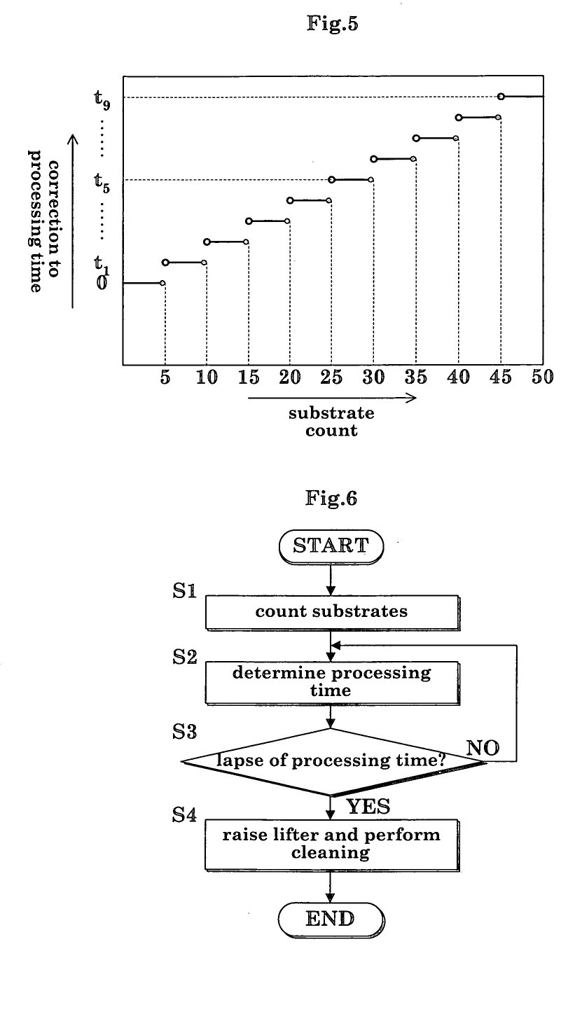

FIG. 5 refers. FIG. 5 shows the relationship between substrate count and processing time stored in the storage unit 43. The horizontal axis represents substrate counts, and the vertical axis represents amounts of correction to the processing time. This embodiment regards, as a reference, a processing time for achieving a desired amount of etching when three wafers W are treated as immersed together in the phosphoric acid solution heated to 150° C., for example. The processing time for achieving the same amount of etching as when three wafers W are treated together is actually measured for groups of eight wafers, 13 wafers, 18 wafers, 23 wafers, 28 wafers, 33 wafers, 38 wafers, 43 wafers and 48 wafers. FIG. 5 shows amounts of correction to the processing time plotted on the vertical axis, which amounts correspond to differences between actual measurements of the processing time for the above groups of wafers W and an actual measurement of the processing time for three wafers W (reference processing time).

Here, where one to five wafers W is/are treated together, the processing time is the same as for three wafers W (i.e. amount of correction=0). Similarly, the processing time (amount of correction) for six to 10 wafers is the same as for eight wafers, that for 11 to 15 wafers the same as for 13 wafers, that for 16 to 20 wafers the same as for 18 wafers, that for 21 to 25 wafers the same for 23 wafers, that for 26 to 30 wafers the same for 28 wafers, that for 31 to 35 wafers the same for 33 wafers, that for 36 to 40 wafers the same for 38 wafers, that for 41 to 45 wafers the same for 43 wafers, and that for 46 to 50 wafers the same for 48 wafers. Of course, the processing time may be varied on a one-by-one basis. Alternatively, a function approximate to the relationship between substrate count and processing time may be stored to determine processing times by using this function.

When, in this embodiment, a count “30” is given as the number of wafers W to be treated together from the substrate counter 41 to the processing time determining unit 42, for example, the determining unit 42 refers to the relationship of FIG. 5 stored in the storage unit 43 and obtains “t5” as an amount of correction to the processing time. The determining unit 42 determines processing time “T+t5” which is the amount of correction t5 to the reference processing time T for three wafers W, to be a proper processing time for treating 30 wafers W together.

FIG. 6 refers. FIG. 6 is a flow chart of the processing time control in this embodiment. The above counting of substrates to be treated collectively corresponds to step S1 in FIG. 6. The process of determining a processing time corresponds to step S2. The controller 40 measures time from a point of time when the lifter 20 lowers to immerse a group of wafers W in the heated phosphoric acid solution, and checks whether the processing time determined in step S2 has expired or not (step S3). When the processing time has expired, the controller 40 outputs a command to a lifter driver 20a (FIG. 3) to raise the lifter 20 to withdraw the wafers W from the phosphoric acid solution for the next cleaning process.

In this embodiment, as described above, wafers W to be treated collectively are counted, and the wafers W are treated as immersed in the heated phosphoric acid solution for a processing time according to the number of wafers W. That is, the time for keeping a group of wafers W immersed in the phosphoric acid solution is extended progressively with increases in the number of wafers W treated together. This compensates for a reduction in the etching rate due to a lowering of the temperature of the phosphoric acid solution by the group of wafers W being immersed. Consequently, even when different lots with different numbers of wafers W are treated to result in differences in lowering of the temperature of the heated phosphoric acid solution, the temperature differences are compensated for by extending or shortening the processing time. Thus, variations in the amount of etching between the lots may be suppressed.

This invention is not limited to the foregoing embodiment, but may be modified as follows:

(1) In the foregoing embodiment, the substrate counting device (substrate counting mechanism 30 and substrate counter 41) forms the substrate count acquiring device for acquiring a count of substrates to be treated collectively. However, the substrate count acquiring device is not limited to the substrate counting device. In a semiconductor manufacturing process, for example, data of the number of wafers W treated collectively may be transmitted to the controller 40 in this embodiment from an external apparatus located upstream of this apparatus or from a control apparatus that controls the entire manufacturing process. Or the operator handling this apparatus may key-input the number of substrates for batch treatment from a control unit (not shown) forming part of the apparatus.

(2) In the foregoing embodiment, the container rest 1 holds one container at a time. The container rest 1 may be adapted to hold a plurality of containers C at a time. In this case, the substrate counting mechanism 7 is arranged for each container C. The substrate transfer robot 2 may be adapted movable horizontally along the container rest 1 to fetch and deposit wafers W from/in each container C.

(3) In the foregoing embodiment, the transmission type sensor 32 is used to detect the number of wafers W in the container C. This detection may be carried out with a reflection type optical sensor or CCD camera, for example.

(4) In the foregoing embodiment, the substrate counting mechanism 30 is mounted on the shutter 9. The substrate counting mechanism 30 may be disposed separately from the shutter 9. The substrate counting mechanism 30 may be mounted on the substrate transfer robot 2.

(5) In the foregoing embodiment, the container C storing a group of wafers W in horizontal posture is placed on the container rest 1. Instead, a container C storing a group of wafers W in vertical posture may be placed on the container rest 1. Then, the posture changing mechanism 3 is made redundant.

(6) In the foregoing embodiment, upon lapse of the processing time according to the number of wafers W treated collectively, the lifter 20 withdraws the group of wafers W up from the phosphoric acid solution, and the group of wafers W treated with the phosphoric acid solution is immersed in pure water in the cleaning tank 23 for cleaning treatment. Alternatively, upon lapse of the processing time, pure water acting as cleaning liquid may be introduced into the treating tank 22 storing the phosphoric acid solution acting as the heated treating solution, to replace the phosphoric acid solution in the treating tank 22 with the pure water for cleaning treatment. In this case, the cleaning tank 23 becomes unnecessary. Of course, the cleaning tank 23 may be retained in place and, after cleaning treatment with the pure water having replaced the phosphoric acid solution in the treating tank 22, cleaning treatment may be carried out again in the cleaning tank 23.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method for performing a predetermined treatment of a plurality of substrates as immersed in a heated treating solution, wherein:
said substrates are immersed in the treating solution for a progressively extended time as said substrates treated increase in number.

2. A substrate treating method as defined in claim 1, comprising:
a step of counting said substrates to be treated;
a step of determining a processing time according to a count of said substrates;
a step of immersing said substrates in said treating solution for said processing time; and
a step of withdrawing said substrates from said treating solution upon lapse of said processing time.

3. A substrate treating method as defined in claim 2, further comprising a step of immersing said substrates in a cleaning liquid after withdrawing said substrates from said treating solution.

4. A substrate treating method as defined in claim 1, comprising:
a step of placing, on a container rest, a container storing said substrates to be treated;
a step of counting said substrates in said container based on a detection of alternating interception and transmission, by said substrates, of light emitted from a light emitter of a transmission type sensor, the detection being made by a light receiver of said transmission type sensor, said transmission type sensor being movable downward with a shutter provided for opening and closing an opening in a partition acting as an atmospheric barrier between said container rest and a treating station;
a step of determining a processing time according to a count of said substrates;
a step of immersing said substrates in said treating solution for said processing time; and
a step of withdrawing said substrates from said treating solution upon lapse of said processing time.

5. A substrate treating apparatus for performing a predetermined treatment of a plurality of substrates as immersed in a heated treating solution, comprising:
substrate count acquiring device for acquiring a count of said substrates to be treated;
storage device for storing beforehand a relationship between count of the substrates and processing time for immersion in the heated treating solution;
processing time determining device for determining a processing time according to the count of said substrates acquired by said substrate count acquiring device, by referring to said relationship stored in said storage device; and
treating device for immersing said substrates in the heated treating solution for the processing time determined by said processing time determining device.

6. A substrate treating apparatus as defined in claim 5, wherein said substrate count acquiring device is a transmission type optical sensor.

7. A substrate treating apparatus as defined in claim 5, wherein said substrate count acquiring device is a reflection type optical sensor.

8. A substrate treating apparatus as defined in claim 5, wherein said substrate count acquiring device is a CCD camera.

9. A substrate treating apparatus as defined in claim 5, further comprising a container rest for receiving a container storing said substrates to be treated, said substrate count acquiring device counts said substrates in said container placed on said container rest.

10. A substrate treating apparatus as defined in claim 9, wherein said substrate count acquiring device is mounted on a shutter provided for opening and closing an opening in a partition acting as an atmospheric barrier between said container rest and a treating station.

11. A substrate treating apparatus as defined in claim 9, wherein said substrate count acquiring device is disposed separately from a shutter provided for opening and closing an opening in a partition acting as an atmospheric barrier between said container rest and a treating station.

12. A substrate treating apparatus as defined in claim 9, wherein said substrate count acquiring device is mounted on a substrate loading robot for fetching said substrates to be treated from said container and depositing treated substrates in said container.

13. A substrate treating apparatus as defined in claim 5, wherein said substrate count acquiring device is arranged to acquire the count of said substrates to be treated, in form of data given from an external device.

14. A substrate treating apparatus as defined in claim 5, wherein said substrate count acquiring device is arranged to acquire the count of said substrates to be treated, in form of a key input from a control unit.

15. A substrate treating apparatus as defined in claim 5, wherein said treating device is arranged to withdraw said substrates from said heated treating solution upon lapse of said processing time, and immerse said substrates in a cleaning liquid.

16. A substrate treating apparatus as defined in claim 5, wherein said treating device is arranged to introduce a cleaning liquid into a treating tank storing said heated treating solution upon lapse of said processing time, to replace said treating solution in said treating tank with said cleaning liquid.
